(19) United States
(12) Patent Application Publication
(10) Pub. No.: US 2007/0139842 A1
(43) Pub. Date: Jun. 21, 2007

(54) Safety lug suitable for the connection to a current outlet

(75) Inventor: Giuseppe De' Longhi, Treviso (IT)

Correspondence Address: THE FIRM OF KARL F ROSS, 5676 RIVERDALE AVENUE, PO BOX 900, RIVERDALE (BRONX), NY, 10471-0900, US

(73) Assignee: DE' LONGHI S.p.A.

(21) Appl. No.: 11/592,914

(22) Filed: Nov. 3, 2006

(30) Foreign Application Priority Data
Dec. 21, 2005 (IT) MI2005A002433

(51) Int. Cl. H02H 5/04

(52) U.S. Cl. 361/103

(57) ABSTRACT

A plug adapted to fit in a standard electrical outlet and supply power through a cord to an electrical device is provided with a thermostat and bistable resettable switch. When one of the plug's prongs is overheated, indicating an overload or short circuit, the thermostat actuates the switch and cuts off power to the electrical device. When the malfunction is repaired, the switch is reset to restore the circuit.

The present invention refers to safety plug suitable for the connection to a current outlet.

As is known, the rated value of the electric voltage of the electrical energy distribution network for domestic use is not equal in all countries.

The user's required electric power being equal, a smaller network voltage leads to a greater current intensity, and consequently a greater dissipation of power due to the Joule effect.

In the countries wherein the network electric voltage is less, therefore, there is a greater exposure to the risk of intense overheating of the current outlet and of the plug inserted in it.

Such overheating may be generated by oxidation and/or aging and loss of elasticity of the contact pieces of the current, outlet, which cause an increase in the electrical contact resistance with the external contacts of the plug, and hence a considerable dissipation of electric energy in heat due to the Joule effect during the circulation of the electric current through the plug. Such overheating may cause a deformation of the plastic cover of the current outlet and consequently a deformation of the plug's plastic cover, even to the point of burning.

Presently, there exist safety plugs with amperometric fuse which disconnect the electrical supply in the case of a short circuit.

The resetting of one such safety plug requires the presence of qualified personnel, who proceed with the substitution of the supply cable and/or fuse and other necessary items, irregardless of whether the malfunctioning depends on the safety plug.

The technical task which the present invention proposes is therefore that of making a safety plug suitable for the connection to a current outlet which permits eliminating the technical drawbacks reported in the prior art.

In the scope of this technical task, one object of the invention is that of making a safety plug suitable for the is connection to a current outlet which is secure and highly reliable, since it is capable of disconnecting the current circulation in the case of an operation anomaly which may produce overheating leading to burning.

Another object of the invention is that of providing a safety plug suitable for the connection to a current outlet, capable of preserving its integrity, and that of the electric supply cable, in case of an operation anomaly which not ascribable to it, which may produce overheating leading to burning.

Not the last object of the invention is that of realizing a safety plug suitable for the connection to a current outlet which is capable of providing the user with information regarding the state of the current outlets in his electrical plant and on the possible need for a maintenance operation.

The technical task, as well as these and other objects according to the present invention, are achieved by making a safety plug suitable for the connection to an electric current outlet according to claim 1.

Other characteristics of the present invention are moreover defined in the subsequent claims.

Further characteristics and advantages of the invention shall be more evident from the description of a preferred but not exclusive embodiment of the safety plug suitable for the connection to an electric current outlet according to the finding, illustrated as indicative and not limiting in the attached drawings, wherein:

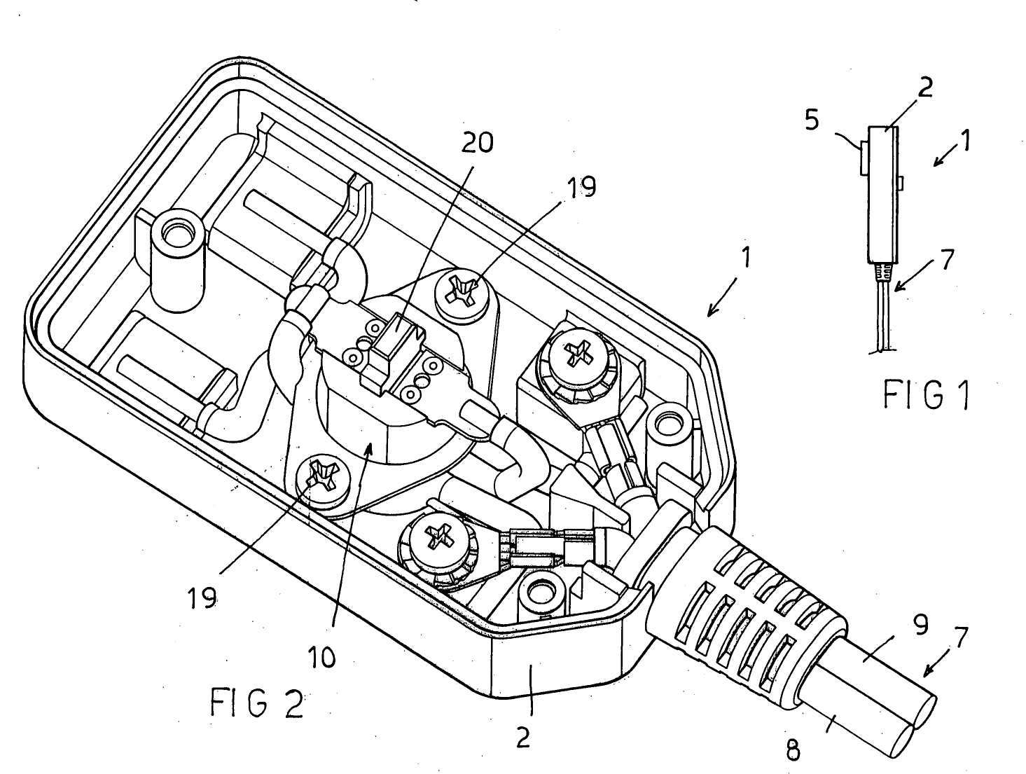

FIG. 1 shows a side elevation view of the safety plug in accordance with a preferred embodiment of the invention;

FIG. 2 shows a perspective view of the safety plug of FIG. 1, from which a part of the cover has been removed in order to show its contents; and

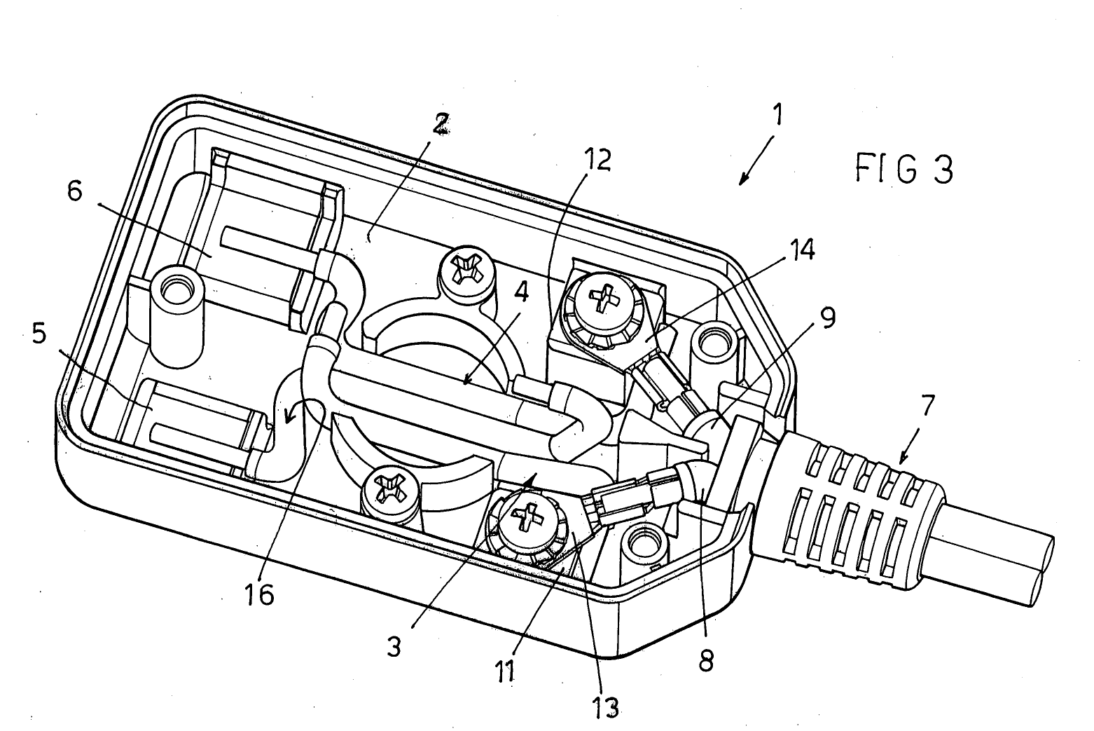

FIG. 3 shows a perspective view of the safety plug of FIG. 2, from which the temperature sensor has also been removed. With reference to the cited figures, a safety plug suitable for the connection to a current outlet is shown, particularly but not exclusive for domestic use, indicated in its entirety with the reference number 1.

The safety plug 1 comprises a cover 2 which contains the electrical connections between the external contacts 5 and 6 of the safety plug 1 suitable for drawing the electric current from the current outlet, and internal contacts 11 and 12 of the safety plug 1 suitable for supplying the user through the electric supply cable 7.

Advantageously, the safety plug 1 has malfunction detection means of the electric current outlet, to which it is connected when electric current circulates.

Such detection means comprise a temperature sensor 10 which is sensitive to the overheating of the current outlet in the case of malfunctioning of the latter.

The electrical connections more precisely comprise a first conductor wire 16 connecting the external contact 5 with the temperature sensor 10, a second conductor wire 3 connecting the temperature sensor 10 with the internal contact 11, to which a phase 8 end of the supply cable 7 is connected by means of a clamp 13, and a third conductor wire 4 connecting the external contact 6 with the internal contact 12, to which a neutral 9 end of the supply cable 7 is connected by means of a clamp 14.

The temperature sensor 10 is preferably a controlling thermostat of at least one opening switch (not shown) of at least one of the electrical connections, in this particular case it opens the circuit between the first conductor 16 and the second conductor 3.

The temperature sensor 10 is in direct contact with at least one of the electrical connections and in this particular case with each of the conductors 3, 4 and 16.

The conductors 3, 4 and 16 are interposed between the bottom surface of the cover 2 and the base of the temperature sensor 10, in turn fixed to the cover 2 through fastening screws 19. Advantageously, the switch controlled by the thermostat is bistable, in particular it is a bistable plate spring: this means that when it commutates, it maintains the switched state even after the signal which caused the commutation has ceased. Thus the switch remains open even after the cooling of the safety plug.

For this reason, manual resetting means of the switch closure are advantageously present.

The resetting means comprise a switch push button 20, present on the outside of the cover 2 on a face of the latter, opposite that wherein the external contacts 5 and 6 are present. During its operation, the push button 20 causes a pressure on the plate spring, which is triggered, reclosing the circuit between the first conductor 16 and the second conductor 3. The safety plug operation according to the invention is evident from that described and illustrated and, in particular, is substantially the following.

Essentially, in the case of current outlet malfunctioning during the circulation of current through the safety plug 1, an overheating occurs which is transmitted from the outlet to the external contacts 5 and 6 of the plug 1 and from these to the internal electrical connections 16 and 4 in contact with the temperature sensor 10, which increases in temperature until the threshold temperature is attained, at which point the plate spring is triggered, opening the electrical connection between the conductors 16 and 3 and therefore disconnecting the current circulation.

The operation of the safety plug may be manually reset only after its cooling, through the reset push button 20.

If the malfunctioning persists, the switch is newly set off, disconnecting the current circulation and thus informing the user of the defective nature of the current outlet.

Of course, modifications and variations beyond those already said are possible; for example, the outer contacts of the safety plug may be cylindrical or blade-like.

The safety plug thus conceived is susceptible to numerous modifications and variations, all falling within the scope of the inventive concept; moreover all details may be substituted with technically equivalent elements.

In practice, any material type or size may be used, according to needs and the state of the art.

1. Safety plug suitable for the connection to an electric current outlet, characterized in that it has detection means of the malfunctioning of said electric current outlet when electric current circulates through said safety plug.

2. Safety plug according to claim 1, characterized in that said detection means comprise a temperature sensor which is sensitive to the overheating produced by said current outlet in the case of its malfunctioning.

3. Safety plug according to claim 1, characterized in that said temperature sensor is a controlling thermostat of at least one opening switch of at least one of the electrical connections, present inside the cover of said plug, between the external contacts of said plug suitable for drawing the electric current from said outlet, and the internal contacts of said plug suitable for supplying the user through an electrical supply cable.

4. Safety plug according to claim 1, characterized in that said temperature sensor is in direct contact with at least one of said electrical connections.

5. Safety plug according to claim 1, characterized in that said temperature sensor is in direct contact with each of said electrical connections.

6. Safety plug according to claim 1, characterized in that said switch is bistable.

7. Safety plug according to claim 1, characterized in that said switch is a bistable plate spring.

8. Safety plug according to claim 1, characterized in that it has manual resetting means of the closure of said switch.

9. Safety plug according to claim 1, characterized in that said resetting means comprise a switching push button outside said cover, on a face of the latter opposite that wherein said external contacts are present.

10. Safety plug suitable for the connection to an electric current outlet as described and claimed.
